(19) United States
(12) Patent Application Publication
(10) Pub. No.: US 2019/0191729 A1
(43) Pub. Date: Jun. 27, 2019

(54) Method And Assembly For Aseptically Heating A Liquid Product In A Heat Exchanger Unit Of The Heater Zone Of A UHT System

(71) Applicant: GEA TDS GmbH, Sarstedt (DE)

(72) Inventors: Uwe Schwenzow, Ahaus (DE); Erwin Süthold, Raesfeld (DE); Wolfgang Schlösser, Ahaus (DE); Franz Tasler, Coesfeld (DE); Hubert Assing, Ahaus (DE); Reinhold Dreckmann, Dülmen (DE)

(21) Appl. No.: 16/327,596

(22) PCT Filed: Aug. 16, 2017
(86) PCT No.: PCT/EP2017/000984

§ 371 Date: Feb. 22, 2019

(30) Foreign Application Priority Data
Aug. 24, 2016 (DE) 102016010099.0
Mar. 28, 2017 (DE) 102017002981.4

(51) Int. Cl. A23C 3/033; F28F 27/00; A23L 3/00; A23L 3/22

(52) U.S. Cl. CPC A23C 3/0337; F28F 27/00; F28D 2021/0042; A23L 3/22; A23L 3/003

(57) ABSTRACT

A method for aseptic heating of a liquid product in a heat exchanger unit in a UHT system is described. The heat exchanger unit is a tubular heat exchanger, in which an indirect heat exchange on a wall takes place between the liquid product and a heating medium by a single heating medium flow with a heating medium inlet temperature flowing in a heat-releasing heating medium chamber between a heating medium inlet and outlet of the heat exchanger unit running countercurrent to a flowing single product flow guided in a heat-absorbing product chamber between a product input and output of the heat exchanger unit. A total heat exchanger path is formed between the product input and output, in which the product flow is heated from a product input temperature to a product output temperature. At least the product output temperature and the heating medium inlet temperature are monitored and regulated.

### CROSS REFERENCE TO RELATED APPLICATION(S)

This application claims priority to German Patent Application No. 10201700298.1, filed Mar. 28, 2017 and German Patent Application No. 102016010099.0, filed Aug. 24, 2016, each of which is herein incorporated by reference in its entirety.

### TECHNICAL FIELD

The invention relates to a method and an assembly for aseptically heating a liquid product in a heat exchanger unit of the heater zone of a UHT system in which an indirect heat exchange on a wall takes place in the heat exchanger unit between the liquid product and a heating medium by a heating medium flow in a heat-releasing heating medium chamber being guided countercurrent to a product flow passing through a heat-absorbing product chamber, with the product flow being heated from a product input temperature to a product output temperature and at least the product output temperature and the heating medium inlet temperature being monitored and regulated. The invention further relates to a heat exchanger unit for such an arrangement.

The liquid products subjected to the heat treatment under discussion can, for example, be not only milk products but also temperature-sensitive food products, in particular desserts or dessert-like products with the entire range of possible viscosities. The invention displays its intended effect in a particularly significant way in the pasteurization zone of a UHT system. There is generally a treatment zone upstream of the heat exchanger unit, such as a preheater zone, or downstream, such as a heat maintenance or cooling zone.

### BACKGROUND

A UHT (ultra-high temperature) process carried out with the UHT system initially mentioned with indirect product heating by heat exchange on a wall using a heat transfer medium or heating medium is understood to be a thermal product treatment, also referred to as aseptic heating, in which virtually all microorganisms are killed, or at least all microorganisms which lead to spoilage, which can propagate at ambient temperature during storage.

Indirect product heating above 100° C. is carried out in a particularly advantageous manner by heat exchange on a wall with tubular heat exchangers, in particular a so-called shell-and-tube heat exchanger. In the latter, the heat energy is transmitted by the tube walls of a group of parallel interior tubes which are preferably oriented horizontally. Here the liquid product to be treated flows in the interior tubes while a heating medium, generally water heated by steam, flows countercurrent in the annular gap space of a jacket tube which surrounds the interior tubes connected in parallel. A shell-and-tube heat exchanger in this regard is known from DE 94 03 913 U1. Indirect product heating of the aforementioned type can also take place with other heat exchanger designs, such as plate heat exchangers.

A known UHT heating device with indirect product heating for producing a UHT milk (DE 10 2005 007 557 A1) contains a preheater in a so-called pre-warming zone for heating the standardized milk. Then the milk is passed through a so-called homogenizer to disperse fat and is then preheated further afterward. So-called maintenance of preheating follows to stabilize the milk proteins. After a further heat exchanger, which is generally run “regeneratively” and is provided for the subsequent milk heating process, the actual UHT heating then takes place in a so-called heater zone with the product kept hot, followed by cooling in a cooling zone with heat exchange using a “regenerative” heat transfer medium, usually water. A “regenerative” heat transfer medium with which a “regeneratively” conducted heat exchange is carried out is understood to be a heat transfer medium which is run in a circuit and, with reference to the direction of flow of the liquid product to be treated, absorbs heat energy from the product in areas of high temperature and “regeneratively” transfers it to the product in areas of low temperature.

Regenerative heat exchange of the aforementioned type is also to be included by the present invention, even if the description below is limited to a heating medium that is not liquid product. The aseptic heating of the liquid product under discussion is effected in a heat exchanger unit of the heater zone of a UHT system, which in particular can also include a pasteurization zone, by a heating medium, such as water heated by steam, which necessarily has a heating medium inlet temperature above that of the product output temperature from the heat exchanger unit characteristic of the aseptic heating process. The aseptic heating is product-specific and takes place in the following exemplary embodiment between a product input temperature T_{PE}=125° C. and a product output temperature T_{PA}=140° C., with the walls of the heat exchanger unit in contact with the product, through which the indirect exchange of heat takes place, needing to have a higher temperature in the assigned temperature curve to ensure the necessary driving forces for the transfer of heat between the walls and liquid product as well as the required efficiency for the heat exchange. Such high wall temperatures pose difficulties, as will be described below.

In the heating method under discussion, more or less heavy deposits occur, particularly in the heater section and in the downstream heat maintenance section, which is not heated externally, or in the heat retention unit. Heat sensitive or temperature sensitive liquid products—with this generic term to be understood particularly as a liquid food product below—can contain a relatively large number of proteins, a lot of dry mass and little water, and their viscosities can cover the entire possible range. Liquid products in this regard, preferably at temperatures above 100° C., tend to scorch, i.e., tend to form deposits on the walls of the heat exchanger unit under these conditions. This deposit formation is also referred to as product “fouling” and can lead to quality problems in the heated liquid product, an end product or an intermediate product and/or to serious cleaning problems. The latter require intensive cleaning cycles and thus reduced operation times for the heat exchanger unit. Thus product fouling reduces the service life and operation time respectively of the heat exchanger unit between two cleaning cycles and is undesirable.

In any case, an effort must be made to ensure that, on one hand, all simultaneously flowing portions of the liquid product to be treated and, on the other hand, all sequential portions are subject as much as possible to the same residence time, particularly in the pasteurization section and the heat maintenance unit, because different dwell times—and thus different treatment times—can work disadvantageously in the manner described above, particularly at high treatment temperatures. The formation of deposits on the hot walls during UHT heating can be significantly reduced by regulated heating of the liquid products in the pre-warming zone with a specific dwell time. Therefore it is important that the process unit situated upstream of the heat exchanger unit provides liquid product to be heated aseptically so that it has the required product input temperature T_{PE}.

The present problem and the disadvantages of prior art in this regard are to be made clear below based on a known heat exchanger unit and a known method which can be carried out with it, which comprise the starting point of the present invention. It is shown in FIGS. 1 and 2.

A detail from an arrangement 10 according to the prior art, which is designed in its un-displayed entirety in FIG. 1 as a UHT system for aseptic heating of a liquid product P, has in its heater or pasteurization zone at least one heat exchanger unit 22, for which, seen in the direction of flow of the liquid product P, there is an upstream process unit 21, for example a heat exchanger of a preheater zone, and a downstream process unit 23, such as a heat maintenance section in the form of a heat retention unit. The schematic representation of the heat exchanger unit 22 can be for a tubular heat exchanger, preferably a so-called shell-and-tube heat exchanger, or for another design as well, with each of these embodiments being able to be subdivided into multiple sequentially connected sections. It is of decisive importance that a total heat exchanger path L be formed between a product input E_{P} and a product output A_{P} of a heat-absorbing product chamber 22.1, through which a product flow F_{P} of the liquid product P passes from right to left with reference to the position in the drawing. The product flow F_{P} enters the product input E_{P} with a product input temperature T_{PE} and exits the product output A_{P} with a product output temperature T_{PA}.

The product chamber 22.1 is in an indirect heat exchange with a heat-releasing heating medium chamber 22.2, through which a heating medium flow F_{M} of a heating medium M passes countercurrent to the product flow F_{P} between a heating medium inlet E_{M} and a heating medium outlet A_{M}. The heating medium flow F_{M} enters the heating medium inlet E_{M} with a heating medium inlet temperature T_{ME} and exits the heating medium outlet A_{M} with a heating medium outlet temperature T_{MA}. A heat flow Q is exchanged between the heating medium chamber 22.2 and the product chamber 22.1. The factors indicated above which include “flow” are to be understood as time-related physical parameters, specifically mass/time (kilograms/second, kg/s) or volume/time (liters/second, dm³/s) and heat quantity/time (joules/second, J/s=W).

A measuring apparatus for product flow 26 measures the product flow F_{P}, a measuring apparatus for product input temperature 28.1 measures the product input temperature T_{PE} and a measuring apparatus for product output temperature 28.2 measures the product output temperature T_{PA}, a measuring apparatus for heating medium flow 29 measures the heating medium flow F_{M} and a measuring apparatus for heating medium inlet temperature 30.1 measures the heating medium inlet temperature T_{ME}.

The measurement variables F_{P}, T_{PE}, T_{PA}, F_{M} and T_{ME} listed above are transmitted to a control and feedback unit 24, which provides a control signal for a target medium inlet temperature T_{ME}* on an output for target heating medium inlet temperature 31.1 and a control signal for a target heating medium flow F_{M}* on an output for target heating medium flow 31.2, with both control signals being in effect for the heating medium M at the heating medium inlet E_{M}.

The temperature curves T_{P}(Iₓ) and T_{M}(Iₓ) shown in FIG. 2 are observed in practice via the operation time of a heat exchanger unit 22 of the type under discussion, with the operation time generally corresponding to the so-called service time between two necessary cleaning cycles. Assigned product temperatures T_{P} and assigned heating medium temperatures T_{M} (both assigned to the Y-axis, for example in degrees Celsius (° C.)) are plotted versus a variable heat exchanger path Iₓ (X-axis). The variable heat exchanger path Iₓ has its origin (Iₓ=0) at the product input E_{P}, and it ends at the product output A_{P} after completing the entire heat exchanger path L (Iₓ=L).

The product-specific temperature curve of the specified, heat-absorbing product flow F_{P} to be treated between the product input temperature T_{PE} (for example, 125° C.) provided by the upstream process unit 21 and the product output temperature T_{PA} (for example, 140° C.) necessary to ensure sufficient aseptic heating is designated by T_{P}(Iₓ). T_{M}(Iₓ) is the designation for two heating medium-specific temperature curves of the heat-releasing heating medium flow F_{M}. The lower temperature curve, with reference to the position in the drawing, between a first heating medium inlet temperature T_{ME}(1) (for example, 140.9° C.) and a first heating medium outlet temperature T_{MA}(1) (for example, 130.6° C.) is at the beginning of the operation time if the heat exchanger unit 22 is still free of any deposits (product fouling) on the product side.

The temperature difference T_{ME}(1)−T_{MA}(1) results from the following balance equation (1):

[symbol]

=F_{P}c_{P}(T_{PA}−T_{PE})=F_{M}c_{M}(T_{ME}(1)−T_{MA}(1))=AkΔTₘ, (1)

where A is an entire heat exchange surface of the heat exchanger unit 22, K is a heat transfer coefficient (see FIG. 1), ΔTₘ is the average logarithmic temperature difference (see FIG. 2), c_{P} is a specific heat capacity of the liquid product P and c_{M} is a specific heat capacity of the heating medium M.

For the countercurrent at the start of the operation time (label (1) in FIG. 2) and the average logarithmic temperature difference ΔT_{M} contained in equation (1), a first average logarithmic temperature difference ΔT_{M}(1) applies according to equation (2.1) with the first heating medium inlet temperature T_{ME}(1) and the first heating medium outlet temperature T_{MA}(1), with the last term of equation (2.1) and the usual abbreviations ΔT_{large}(1) and ΔTₛₘₐₗₗ(1) for the respective temperature differences on the end side resulting as follows:

$$Δ {T}_{m} ( 1 ) = \frac{( {T}_{MA} ( 1 ) - {T}_{PE} ) - ( {T}_{ME} ( 1 ) - {T}_{PA} )}{ln \frac{{T}_{MA} ( 1 ) - {T}_{PE}}{{T}_{ME} ( 1 ) - {T}_{PA}}} = \frac{Δ {T}_{large} ( 1 ) - Δ {T}_{small} ( 1 )}{\frac{Δ {T}_{large} ( 1 )}{Δ {T}_{small} ( 1 )}} . \qquad ( 2.1 )$$

In the course of the operation time, the deposits increase continuously on the product side and the heat transfer coefficient k is likewise continuously reduced by this. Then the temperature differences between the liquid product P and the heating medium M provided at the beginning of the operation time no longer suffice to transfer the necessary heat flow Q for heating the product flow F_{P} to the necessary product output temperature T_{PA}. At the end of the operation time, after 12 hours for example, the control and feedback unit 24 has increased the heating medium inlet temperature T_{ME} so much that a second heating medium inlet temperature T_{ME}(2) (for example, 144.5° C.) is now necessary at the heating medium inlet E_{M}, from which, according to equation (1), a second heating medium outlet temperature T_{MA}(2) (for example, 134.2° C.) results.

For the end of the operation time (label (2) in FIG. 2), analogous to equation (2.1), according to equation (2.2), a second average logarithmic temperature difference ΔT_{M}(2) results with the second heating medium inlet temperature T_{ME}(2) and the second heating medium outlet temperature T_{MA}(2) and the abbreviations introduced above and adapted correspondingly (ΔT_{large}(2), ΔTₛₘₐₗₗ(2)):

$$Δ {T}_{m} ( 2 ) = \frac{( {T}_{MA} ( 2 ) - {T}_{PE} ) - ( {T}_{ME} ( 2 ) - {T}_{PA} )}{ln \frac{{T}_{MA} ( 2 ) - {T}_{PE}}{{T}_{ME} ( 2 ) - {T}_{PA}}} = \frac{Δ {T}_{large} ( 2 ) - Δ {T}_{small} ( 2 )}{\frac{Δ {T}_{large} ( 2 )}{Δ {T}_{small} ( 2 )}} . \qquad ( 2.2 )$$

The second heating medium outlet temperature T_{MA}(2) necessarily set at the heating medium outlet A_{M} is, as can be derived from equation (1) with corresponding values, substantially dependent on a second mass flow ratio f(2), formed as a quotient of a second heating medium flow F_{M}(2) divided by the product flow F_{P} on one hand (f(2)=F_{M}(2)/F_{P}; generally: f=F_{M}/F_{P}), the respective specific heat capacities c_{M} of the heating medium M and c_{P} of the liquid product P as well as from the heat transfer conditions (characterized by the heat transfer coefficient k) also influenced by the growing deposits on the walls of the heat exchanger unit 22 on which the heat exchange takes place. In the present case, to ensure that the necessary product output temperature T_{PA} is achieved under all operating conditions and this is therefore also applicable to the lower heating medium-specific temperature curve set at the beginning of the operation time with a first heating medium flow F_{M}(1), i.e., with f(1)=F_{M}(1)/F_{P} during the entire operation time the heat exchanger unit 22 is operated with a constant mass flow ratio f, in which the heating medium flow F_{M} exceeds the product flow F_{P} by almost 50% (f=f(1)=f(2)=1.43=constant; see FIG. 2).

A further increase of the heating medium inlet temperature T_{ME} is no longer possible, because the heater power cannot be or is not permitted to be increased further via the heating medium M and/or because the pressure drop due to accumulated deposits on the product side exceeds a permitted extent.

The deposits accumulated during the operation time can also be recognized by the specialist from the average logarithmic temperature difference ΔT_{M}, which, according to equation (1), is required in order to transfer the heat flow Q in the respective load condition of the heat exchanger unit 22 with these deposits. In the present case, at the beginning of the operation time, the first average logarithmic temperature difference ΔT_{M}(1) is 2.6° C. and at the end of the operation time the second average logarithmic temperature difference ΔT_{M}(2) is 6.6° C.

As FIG. 1 shows, in the heat exchanger unit 22 in the arrangement 10 according to prior art necessary measurement is performed for the product input temperature T_{PE}, the product output temperature T_{PA}, the heating medium inlet temperature T_{ME} and the product flow F_{P} and heating medium flow F_{M} at the respective assigned product input E_{P} and/or product output A_{P} and/or heating medium inlet E_{M} and used for control and/or regulation. The temperatures T_{P} of the product flow F_{P} inside the heat-absorbing product chamber 22.1 and temperatures T_{M} of the heating medium flow F_{M} inside the heat-releasing heating medium chamber 22.2 and in its direction of extension are not recorded, so the actual temperature curves are not known in the course of the operation time, with the exception of the previously mentioned marginal temperatures T_{PA}, T_{PE} and T_{ME}.

A product-specific temperature limit curve of the product flow F_{P}—designated in FIG. 2 as T_{P}(Iₓ)′—is theoretical in nature with respect to its linear plot between the product input temperature T_{PE} and the product output temperature T_{PA}, just like a linear temperature curve in the heating medium flow F_{M}, which is not shown. These linear plots would only occur if the specific heat capacities c_{P} and c_{M} of the product P and heating medium M respectively and the physical parameters determining the heat throughput, indicated by the heat transfer coefficient k, were independent of temperature and a quantitatively and qualitatively uniform deposit formation were to occur over the entire heat exchange surface A, which is not the case in practice. Nevertheless, as part of the influencing parameters available, it is worth the effort to bring the actual product-specific temperature curve T_{P}(Iₓ) and the heating medium-specific temperature curve T_{M}(Iₓ) as close as possible to the respective linear temperature limit curve, because the quantitative heat exchange over the entire heat exchanger path L is more uniform by doing so.

Based on the case example of FIG. 2 and the underlying design data for it, measurement of the product flow F_{P} shows that after a discrete heat exchanger path Iₓ=Iₓ₁, already about at the beginning of the last third of the entire heat exchanger path L, there is a discrete temperature of the liquid product T_{P}(Iₓ₁) which nearly corresponds to the product output temperature T_{PA} first required at the product output A_{P}. This circumstance is not easily anticipatable without discrete measurement during the dimensioning of the heat exchanger unit 22 and in the definition of the operating data, particularly as the heat exchanger unit 22 is operated with the previously mentioned mass flow ratio f=1.43 for safety reasons. Furthermore, the greatest variety of liquid products P with the most diverse formulations are heat treated in an arrangement 10 of the type under discussion, with the most diverse raw material requirements, viscosities, quality criteria and production conditions to be considered. It is to be assumed that the aforementioned circumstance, which in the final result means that the heat exchanger unit 22 is either over-dimensioned or is not operated in an optimal manner, is no isolated case under the boundary conditions mentioned which are to be met.

Even further disadvantages are apparent from the case example described, which concern an undefined residence time of the liquid product P at the level of the product output temperature T_{PA} and the degree and distribution of the deposit formation in each case in the heat exchanger unit 22.

It is known that the tendency to form deposits and the rate of deposit buildup are significantly influenced not only by the level of temperature for the heat-releasing wall itself but also decisively by the difference between the wall temperature and the temperature of the liquid product P at this point. In the case example shown by FIG. 2, at the product output A_{P} and heating medium inlet E_{M} respectively the product temperature T_{P} and thus necessarily also the heating medium temperature T_{M} are at their highest in each case, while at the beginning of the operation time the necessary temperature difference between the first heating medium inlet temperature T_{ME}(1) and the product input temperature T_{PE} is kept as small as possible (in the case example, T_{ME}(1)−T_{PA}=ΔTₛₘₐₗₗ(1)=0.9° C.).

At the product input E_{P} and heating medium outlet A_{M} respectively, the product input temperature T_{PE} and thus also the heating medium outlet temperature T_{MA} is naturally at the lowest, while at the beginning of the operation time according to equation (1) the change of the heating medium temperature T_{M} between the heating medium inlet E_{M} and the outlet A_{M} does not depend only on the necessary temperature difference between the product output temperature T_{PA} and the product input temperature T_{PE}, but also on the mass flow ratio f=f(1)=1.43. In the case example, T_{MA}(1)−T_{PE}=ΔT_{large}(1)=5.6° C. The temperature difference T_{M}−T_{P} thus increases continuously in the clean heat exchanger unit 22 not fouled with product from the product output A_{P} with ΔTₛₘₐₗₗ(1)=0.9° C. to the product input E_{P} with ΔT_{large}(1)=5.6° C. (by a factor of 6.2), which, in the course of the operation time, leads to further deposit growth due to the the deposit formation caused by the product-specific temperature curve T_{P}(Iₓ), said growth being approximately proportional to the temperature difference T_{M}−T_{P} and magnified by a factor of 6.2 at the start of the operation time.

At the end of the operation time in the case example, the result is T_{ME}(2)−T_{PA}=ΔTₛₘₐₗₗ(2)=4.5° C. and T_{MA}(2)−T_{PE}=ΔT_{large}(2)=9.2° C. (about a factor of 2). Seen altogether, in the course of the operation time one finds that the deposit grows continuously everywhere on the entire heat exchanger path L, with the deposit thickness increasing from the product output A_{P} to the product input E_{P} because the temperature differences between the heating medium M and thus between the wall and liquid product P increase in this direction and at all times. The deposit has a significant influence on the heat transfer on the product side and thus on the heat transfer coefficient k. Since the heat exchanger unit 22 is operated during the entire operation time with a constant mass flow ratio f=f(1)=f(2)=1.43, the increase of the temperature difference from ΔTₛₘₐₗₗ(1)=0.9° C. to ΔTₛₘₐₗₗ(2)=4.5° C. at the product output A_{P} and from ΔT_{large}(1)=5.6° C. to ΔT_{large}(2)=9.2° C. at the product input E_{P} can only be explained by the change in the thickness of the deposit on one hand and by the increase of the deposit thickness toward the product input E_{P} on the other hand and thus essentially by the change of the heat transfer coefficient k as a function of the heat exchanger path Iₓ and of the operation time.

With the current manner of operation for the heat exchanger unit 22, the disadvantages to be found are summarized as follows.

After starting the clean heat exchanger unit 22 and setting a stationary product input temperature T_{PE} and a stationary product output temperature T_{PA} it is not recognizable whether the latter is already reached prior to the product output A_{P} and thus whether the heat exchanger unit 22 is operated in an optimal manner.

For the case that the product output temperature T_{PA} or one which deviates only slightly from it is reached prior to the product output A_{P}, for example at the position Iₓ=Iₓ₁<L, the remaining section L−Iₓ₁ acts as a heat maintenance section in the heat exchanger unit 22, and the liquid product P already experiences an undefined and undesired residence time from this, which can adversely affect its quality.

The high mass flow ratio f=(f(1)=f(2)=constant, which remains the same throughout the entire operation time, results in acceptance of uneconomical operation, at least in the first part of the operation time.

The significant increase of the temperature difference over the entire heat exchanger path L from ΔTₛₘₐₗₗ(1) to ΔT_{large}(1) (a factor of 6.2) at the start of the operation time and then until the end of the operation time again from ΔTₛₘₐₗₗ(2) to ΔT_{large}(2) (about a factor of 2), considered over the entire heat exchange surface A, results altogether in a load quantity from product fouling which is generally, and particularly in the area of the product input E_{P}, larger than it would be if the preceding increase of the temperature differences, which is fundamentally and as a tendency to be tolerated throughout the operation time, were smaller.

The load mass which collects determines the service time of the heat exchanger unit 22 in the pasteurization zone of the arrangement 10, i.e., the possible operation time as a time between two necessary cleaning cycles. The deposit formation observed with the manner of operating the heat exchanger unit 22 up to now and the resulting load size by mass and distribution lead to a reduction of the service time.

WO 2014/191062 A1 describes a method for determining the degree of heat treatment for a liquid product in a processing system for liquid products in which this known method preferably refers to the pasteurization of these liquid products in the temperature range from 10 to 100° C. and contains no indication of transfer to a heating or pasteurization in UHT processes. The determined degree of heat treatment is a so-called heat treatment index value comparable with so-called pasteurizing units, which the specialist can determine from a generally known mathematical relationship for the respective liquid product into which the temperatures imposed on the liquid product in particular time segments in the course of its heat treatment are input.

It is a task of the present invention to create a method of the generic type and an arrangement for carrying out the method and a heat exchanger unit for this arrangement, which, in the treatment of liquid products, particularly temperature sensitive food products of the type initially mentioned, can altogether reduce the product fouling in the areas adjacent to the product input of the heat exchanger unit and beyond and thus significantly extend the service time of the heat exchanger unit.

### BRIEF SUMMARY

In terms of technical method, this disclosure starts from a method for aseptic heating of a liquid product, such as temperature sensitive food products, in particular milk products, desserts or dessert-like products, with the entire range of possible viscosities, in a heat exchanger unit of the heater or pasteurization zone of an arrangement in a UHT system. An indirect heat exchange on a wall takes place here in the heat exchanger unit between the liquid product and a heating medium by a heating medium flow running in a heat-releasing heating medium chamber countercurrent to a product flow running in a heat-absorbing product chamber. The product flow is heated from a product input temperature to a product output temperature, with at least the product output temperature and the heating medium inlet temperature being monitored and regulated in the process, with the product input temperature also being monitored as part of a particularly secure process control and possibly being regulated by a process unit upstream of the heat exchanger unit.

An object underlying the invention is solved according to a first method if, in the method of the generic type, the following method steps (A1), (B1), (C), (D1), (E), and (F) are provided. An object underlying the invention is solved according to a second method if, in the method of the generic type, the following method steps (A2), (B2), (C), (D2), (E), and (F) are provided.

The basic idea herein consists for both methods of the necessity of solving the object at hand by ensuring an optimal product-specific and an optimal heating medium-specific temperature curve throughout the entire operation time of the heat exchanger unit, and that this can only succeed if at least information is available about the temperature of the product flow at least in an area upstream of the product output, said information enabling suitable control and regulation of the heating medium flow. With this information and the proposed method steps, product fouling is reduced in the heat exchanger unit on the whole and particularly in the regions adjacent to the product output.

The first method includes: (A1) setting an unknown product-specific temperature curve between the product input temperature and the product output temperature with the aid of a supply of the required heating medium flow with the required heating medium inlet temperature into the heating medium chamber at a heating medium inlet. This setting is accompanied by measuring discrete product temperatures at specified measurement points in the product flow, with at least the product output temperature and usually also the product input temperature being recorded via further specified measurement points. The product-specific temperature curve resulting from these measurements is provided for further processing according to method step (D1).

The method step (A1) is applied if no adequate empirical values are available for the liquid product and only the endpoints of the temperature curve, particularly the product input temperature and product output temperature, are necessarily specified. The method step of adding the heating medium flow with the heating medium inlet temperature is to be understood such that at first minimum values are chosen for both the heating medium inlet temperature and the heating medium flow, with which is precisely guaranteed to reach and maintain the product output temperature and product input temperature. Consequently, operation is not carried out as previously with a high mass flow ratio (=heating medium flow/product flow) throughout the entire operation time for safety reasons, with the ratio being sufficient in magnitude for the end of the operation time, but instead with a significantly smaller ratio.

The first method includes: (B1) specifying the product input temperature at a product input into the product chamber and the product output temperature at a product output from it and providing the heating medium inlet temperature and heating medium flow.

The method steps of specifying and providing are to be understood such that these quantitative instructions are saved in a control and feedback unit in conjunction with the necessary control algorithms.

The first method includes: (C) measuring a product-specific temperature curve between the product output and the product input at the specified measurement points.

This method step is to be understood such that in the course of the operation time, if the formation of deposits increases, and in fact after setting the unknown product-specific temperature curve according to method step (A1), the product-specific temperature curve is measured in each case and provided for further processing according to the subsequent method step (D1).

The first method includes: (D1) comparing the temperature curves for method steps (A1) and (C) and calculating temperature deviations at the specified measurement points.

This method step provides, as a consequence of the growing deposit, possible changes to the product-specific temperature curve upward or downward, expressed by the respective temperature deviation determined, where a “drop” of the product output temperature by 3° C., for example, can mean that the liquid product is no longer aseptic when it leaves the heat exchanger unit. The temperature deviation determined can be positive or negative.

The first method includes: (E) specifying a permitted temperature deviation.

This specification is dependent on the liquid product and the respective formulation and is saved in the control and feedback unit for further processing. Due to the possible positive or negative temperature deviation, it is positive and negative and may differ in amount.

The first method includes: (F) changing of the heating medium inlet temperature to a target heating medium inlet temperature when the permitted temperature deviation is exceeded by the calculated temperature deviation.

The method step of changing is to be understood such that when the permitted temperature deviation is exceeded on the high or low side, an instruction or algorithm is stored in the control and feedback unit, according to which at first only the target heating medium inlet temperature is changed with which the product-specific temperature profile is brought back into the range of the permitted temperature deviation. The corresponding magnitudes of the deviations in question are compared with one another for this purpose.

In the second method, the explanation can be limited to the method steps (A2) and (B2), because the further method steps (C), (D2), (E) and (F) are identical in content to the corresponding method steps (C), (D1), (E) and (F).

The second method includes: (A2) setting a known product-specific target temperature curve with the aid of measuring discrete product temperatures at specified measurement points in the product flow and with the aid of a supply of the required heating medium flow with the required heating medium inlet temperature into the heating medium chamber at a heating medium inlet.

This method step of setting is to be understood such that a known product-specific target temperature curve stored in the control and feedback unit is controlled and adjusted with the aid of measurements for discrete product temperatures at specified measurement points in the product flow, during which at least the product output temperature and generally also the product input temperature are recorded at other specified measurement points. This temperature curve, which is set and measured and corresponds as much as possible to the specified known product-specific temperature curve, is provided for further processing according to method step (D2).

The method step is applied if sufficient empirical values are available from previous heating processes for the liquid product to be heated and thus an achievable, product-specific target temperature curve is available which includes the endpoints of the temperature curve which need to be specified, specifically the product input temperature and product output temperature.

The method step of supplying the heating medium flow with the heating medium inlet temperature is to be understood such that these operating data are known and kept ready to ensure that the known product-specific target temperature curve is achieved and maintained. Consequently, operation is not carried out as previously with a high mass flow ratio throughout the entire operation time for safety reasons; instead, these operating data are minimized or optimized at least for the beginning of the operation time.

The second method includes: (B2) specifying the known product-specific target temperature curve; this includes the product input temperature at a product input into the product chamber and the product output temperature at a product output out of it, and providing a stored supply of the heating medium flow with the heating medium inlet temperature.

The method steps of specifying and providing are to be understood such that these quantitative instructions are saved in the control and feedback unit in conjunction with the necessary control algorithms.

Considered over the operation time, the heating medium inlet temperature must be changed on account of the deposit growth, i.e., it must be increased in order to compensate for the decreasing heat throughput. According to one proposal, this is achieved by changing the heating medium inlet temperature to the required target heating medium inlet temperature in each case either in temperature steps, which can preferably be very small, or by a continuous temperature change. In both cases, very sensitive temperature control can be achieved.

The increase of the heating medium inlet temperature is limited on one hand by the options available in the process installation for representing these temperatures and on the other hand by considerations of efficiency. A further limitation of the heating medium inlet temperature is imposed by the rate of temperature increase, i.e., by the change of temperature in a specified time span. This temperature gradient, for example in degrees Celsius per hour (° C./h), provides an indication of the rate of growth for the deposit and thus of the available service time for the heat exchanger unit.

A further embodiment of the method which applies equally to the first and second methods provides the following method steps:
(G) Determining a temperature/time gradient from a change of the heating medium inlet temperature in a specified time span.
(H) Specifying a reference gradient for a permitted temperature increase of the heating medium inlet temperature in the time span.
(I) Comparing the results of method step (G) with the specification according to method step (H).
(J) Changing the heating medium flow to a target heating medium flow when the reference gradient is exceeded by the temperature/time gradient determined.

Because the first and second methods are started with an exactly necessary mass flow ratio at the beginning of the operation time, significant quantity-related increases in the heating medium flow up to the end of the operation time, which find their limit where the known method starts from at the beginning of the operation time due to safety considerations, remain as part of the resources of the process installation and the required efficiency.

In consideration of the change to the heating medium flow, one embodiment of the method provides that the change of the heating medium flow to the necessary target heating medium flow takes place in each case either by a stepwise or a continuous increase. In both cases, with corresponding design, this can support finely adjusted regulation of the medium's inlet temperature on one hand and on the other hand limit a temperature difference between the product and heating medium temperature in the direction of the product input or the heating medium outlet to the degree exactly necessary. This measure ensures that the tendency to increased deposit formation driven by the temperature difference is minimized. An indication of the increasing growth of the deposit is also given by another embodiment of the method in which a product inlet pressure is measured at the product input and a product outlet pressure is measured at the product output.

One arrangement for carrying out a method according to the invention starts from a known UHT system with a heat exchanger unit in the heater zone which, seen in the direction of flow of a liquid product to be heated indirectly, is situated between an upstream process unit and a downstream process unit. The heat exchanger unit has a flow-through heat-absorbing product chamber and a flow-through heat-releasing heating medium chamber. Furthermore, at least one measuring apparatus for product flow, one measuring apparatus for product input temperature, one measuring apparatus for product output temperature, one measuring apparatus for heating medium flow and one measuring apparatus for heating medium inlet temperature are provided. These measuring apparatuses are connected with a control and feedback unit which, dependent on these measuring apparatuses, controls an output for target heating medium inlet temperature and an output for target heating medium flow which are provided on the control and feedback unit.

According to the teachings herein, it is provided, starting from the previously specified known assembly, that at least one temperature measurement point be provided in the product chamber of the heat exchanger unit upstream of a product output and adjacent to it with a defined spacing, said measurement point being connected in each case to the control and feedback unit via an associated measuring apparatus for discrete product temperature for measuring discrete product temperatures. Information on the product-specific temperature curve inside the product chamber is obtained with this at least one temperature measurement point, and this is done in fact in an area adjacent to the product output. In each case, this area has a defined spacing from the product output; this spacing is preferably directly adjacent to the product output.

The product-specific temperature curve in the area under discussion is recorded all the more exactly according to one proposal if more than one temperature measurement point is provided. In this case, the temperature measurement points are situated in series with respect to one another and with defined spacing from one another contrary to the direction of flow of the liquid product.

It has been found to be sufficient if the at least one temperature measurement point or points is or are arranged at least in the last third of the flow-through product chamber. This area can be detected in this way, enabling it to be recognized whether the heat exchange surface of the heat exchanger unit is utilized optimally and thus efficiently and whether the quality of the liquid product is at risk from a maintenance of heat with undefined residence time already occurring in this zone.

One heat exchanger unit according to the teachings herein, which is suited in the sense of an object according to the invention for aseptic heating in a heater zone of an arrangement in a UHT system, is subdivided into multiple sections connected to one another in series. Here, adjacent sections on the product side are connected to one another in each case via a first connecting element through which liquid product flows and on the heating medium side via a second connecting element. The respective temperature measurement point is provided in the first connecting element. The sectional construction of the heat exchanger unit enables conceivably simple access to the area of the heat-absorbing product chamber under discussion upstream of the product output. One very simple arrangement of a temperature measurement point is given in each of these first connecting elements assigned to this area without having to engage in a complicated manner with the product chamber itself, where the heat exchange takes place.

The preceding measures are accomplished in a particularly simple and useful manner according to one further proposal if the heat exchanger unit is designed as a tubular heat exchanger and if the individual section of the tubular heat exchanger is formed in each case on the product side as a monotube through which liquid product flows or as a tube bundle with a number of parallel interior tubes through which liquid product flows. Here the first connecting element is preferably formed in each case as a connecting bend or as a connection fitting.

### BRIEF DESCRIPTION OF THE DRAWINGS

A more detailed representation of the invention is found in the following description and the drawing figures provided as well as in the claims. While the invention is implemented in the most varied embodiments of a first and a second method of the generic type, with the most varied embodiments of an arrangement for carrying out the method and the most varied embodiments of a heat exchanger unit for such an arrangement, the two methods, a preferred embodiment of an arrangement according to the invention which accommodates an heat exchanger unit according to the invention, and two advantageous embodiments of the heat exchanger unit are described below based on the drawing.

FIG. 1 is a schematic representation of a section from a prior art UHT system for aseptic heating of a liquid product and a heat exchanger unit of the heater or pasteurization zone.

FIG. 2 a qualitative representation of the temperature curves of the liquid product to be heated and of the heat-releasing heating medium, which show the temperatures on the Y-axis and a variable heat exchanger path in a schematically shown prior art heat exchanger unit on the X-axis.

FIG. 3 is a flow diagram of a first and a second method for aseptic heating according to the teachings herein.

FIG. 4 is a schematic representation of an arrangement with a heat exchanger unit for carrying out the two methods according to FIG. 3.

FIG. 5 is a diagram for representing the temperature curves in the heat exchanger unit according to FIG. 4.

FIG. 6A is a front view of a preferred embodiment of the heat exchanger unit according to FIG. 4.

FIG. 6B is a schematic and enlarged representation of a first embodiment of the heat exchanger unit according to FIG. 6A based on a detail in reference to the formation of the heat-absorbing product chamber labeled there with “Z”.

FIG. 6C is a schematic and enlarged representation of a second embodiment of the heat exchanger unit according to FIG. 6A based on a detail in reference to the formation of the heat-absorbing product chamber labeled there with “Z”.

### DETAILED DESCRIPTION

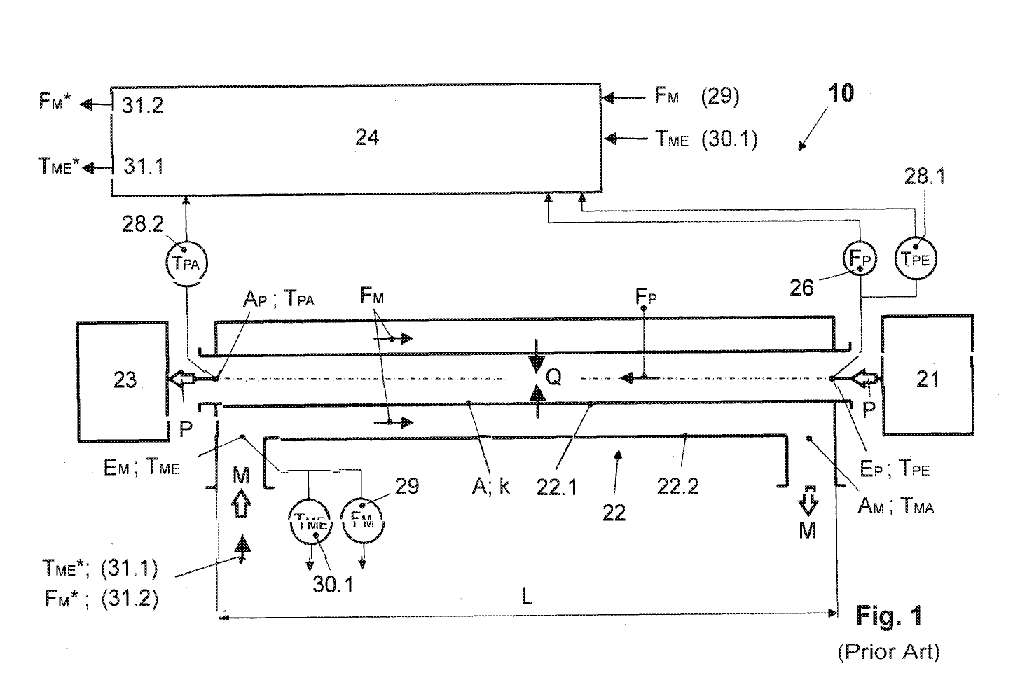

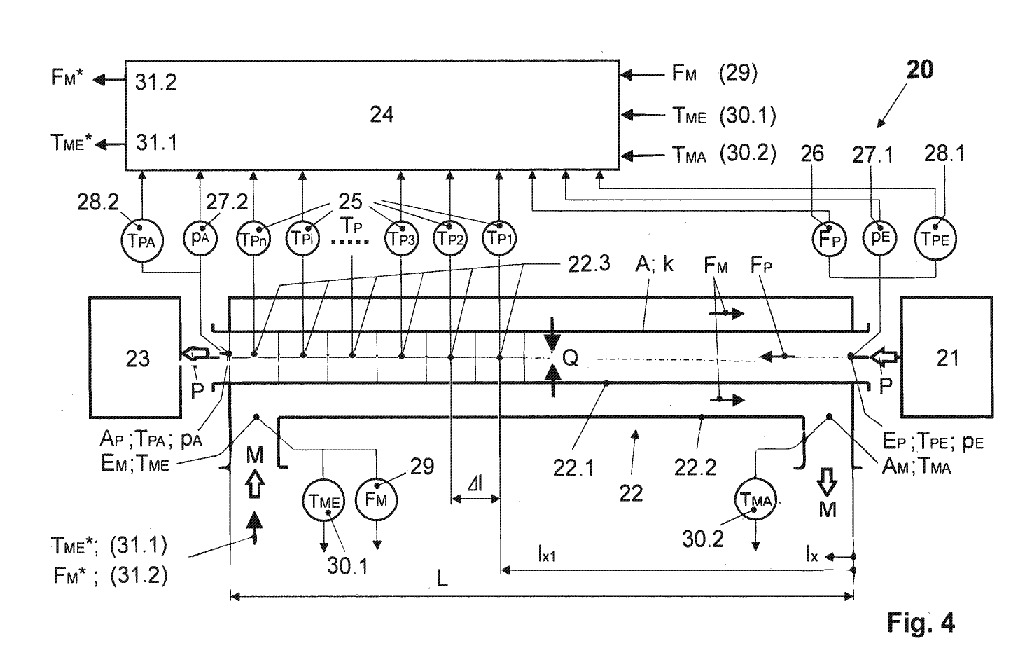

An arrangement 20 according to FIG. 4, which represents a section from a UHT system, is largely identical in its basic construction with the previously described arrangement 10 according to FIG. 1. Therefore, a renewed description in this regard is omitted. The difference between the arrangement 10 and the arrangement 20 consists of the fact that in the product chamber 22.1 of the heat exchanger unit 22 at least one temperature measurement point 22.3 is provided upstream of the product output A_{P} and adjacent thereto. The at least one temperature measurement point 22.3 in the embodiment has a spacing from the product input E_{P}, which is designated with a discrete heat exchanger path Iₓ₁, and thus has a defined spacing L−Iₓ₁ from the product output A_{P} according to the measure of an entire heat exchanger path L. The temperature measurement points 22.3 are situated in series with respect to one another and spaced from one another with a defined measurement point interval Δl, contrary to the direction of flow of the liquid product P. Each of these measurement points 22.3 is connected to the control and feedback unit 24 via an associated measuring apparatus for discrete product temperature 25 in each case for measuring discrete product temperatures T_{P} or T_{P1} to T_{Pn}. Furthermore, it is provided that a measuring apparatus for product inlet pressure 27.1 measures a product inlet pressure p_{E} and a measuring apparatus for product outlet pressure 27.2 measures a product outlet pressure p_{A}. An optional measuring apparatus for heating medium outlet temperature 30.2 measures the heating medium outlet temperature T_{MA}.

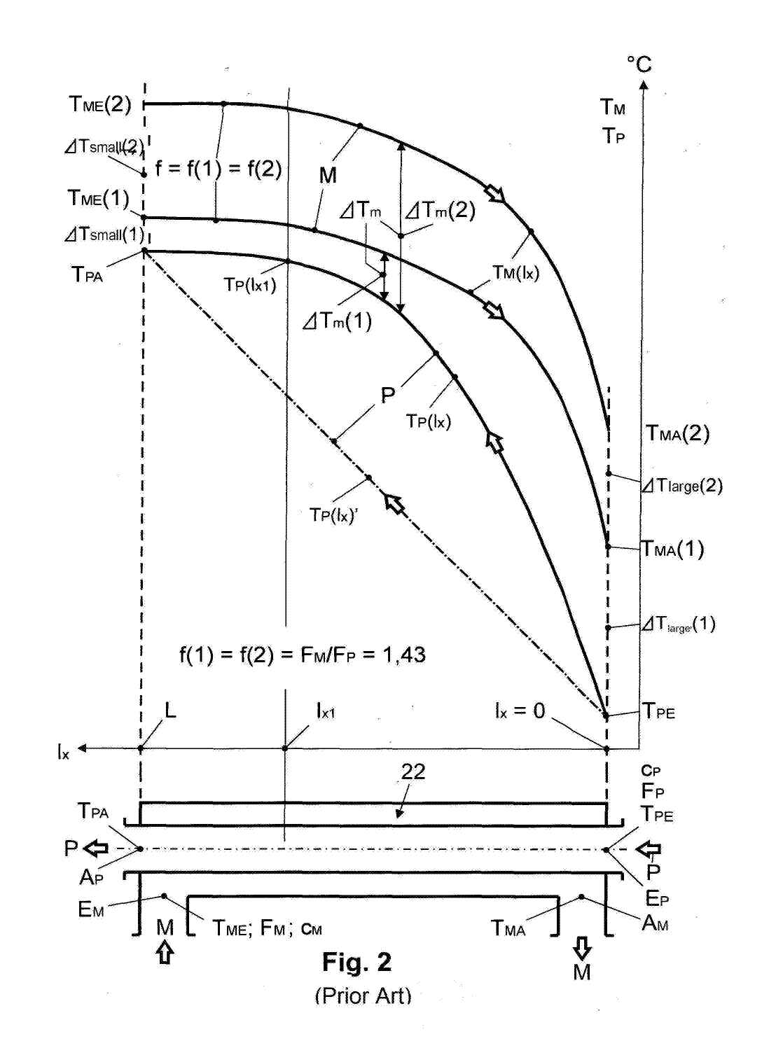

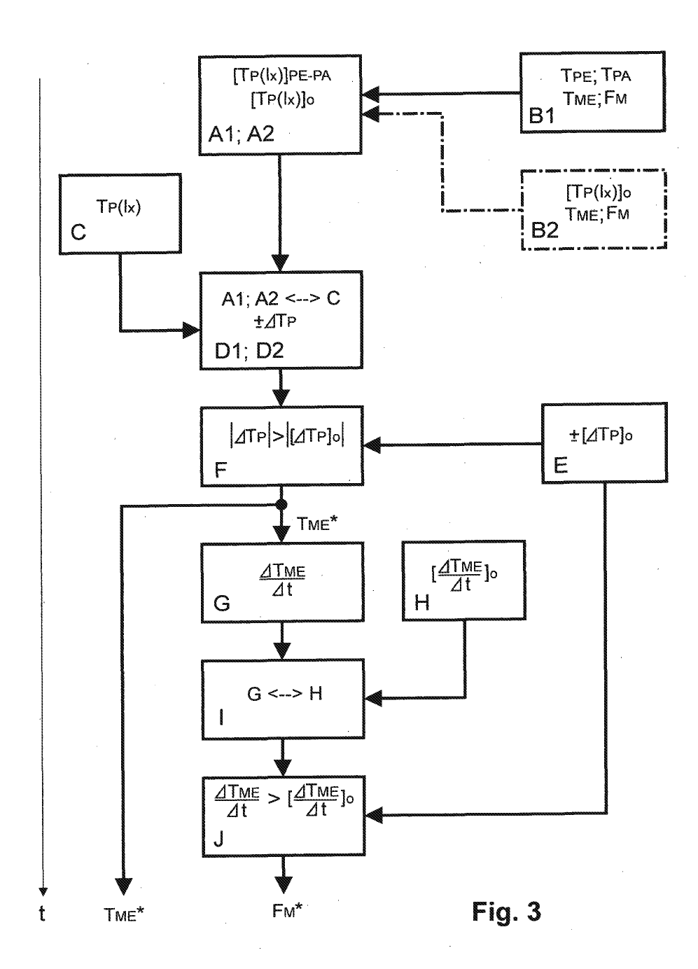

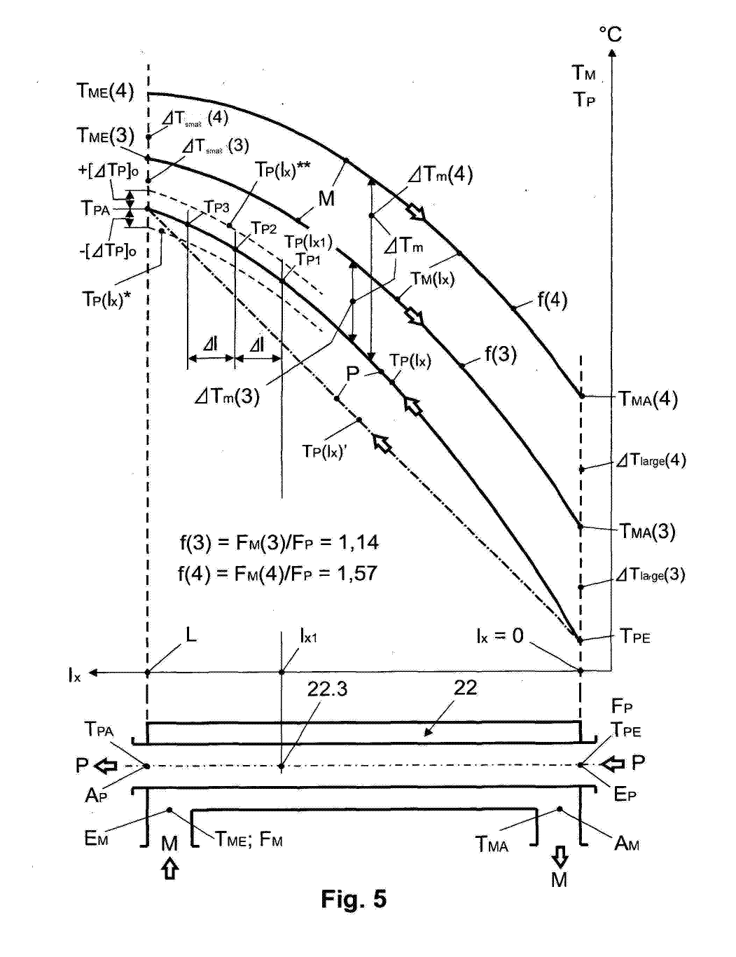

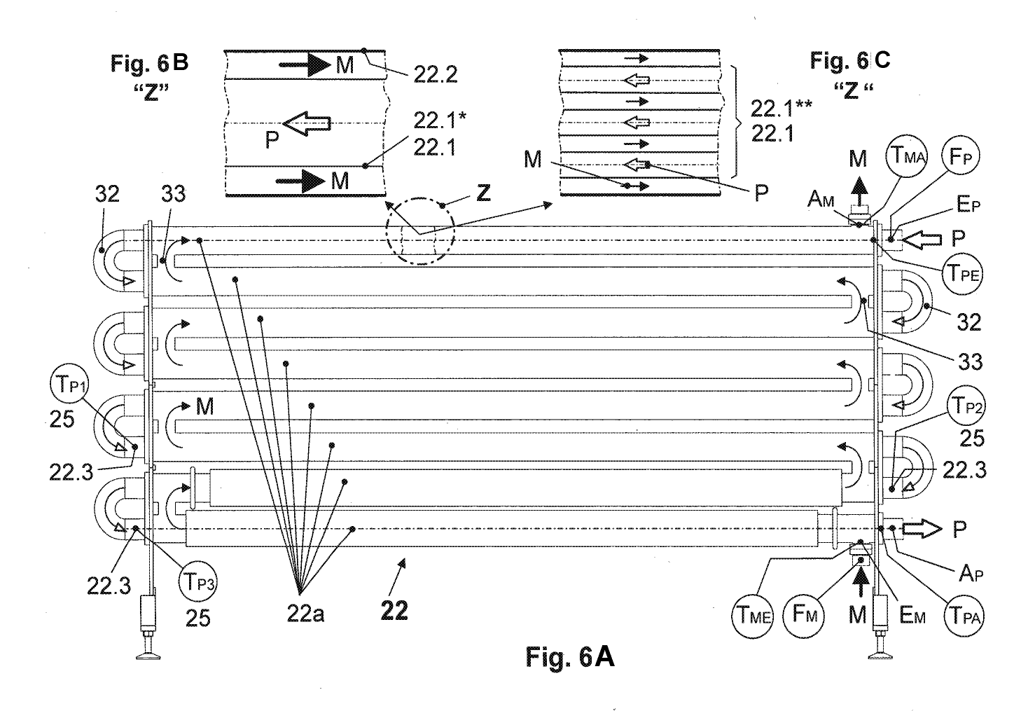

The features and reference values in FIG. 2, which were defined and explained above, are also found identically or in a modified form only with regard to designation to some extent in FIG. 3 and predominantly in FIGS. 5 and 6A-6C. In this regard as well, a renewed definition and explanation is omitted below. With reference to the subject matter of the invention, only the additional or different features and reference values will be introduced and explained.

The first and second methods according to the invention are illustrated in FIG. 3, in each case in connection with a further embodiment advantageous for both methods, in the form of a flow diagram during the time t increasing downward (on the vertical axis).

### First Method

The first method starts from the known method for aseptic heating of a liquid product P in a heat exchanger unit 22 of the heater zone of an arrangement 20 in a UHT system in which an indirect heat exchange on a wall takes place in the heat exchanger unit 22 between the liquid product P and a heating medium M by a heating medium flow F_{M} in a heat-releasing heating medium chamber 22.2 being guided countercurrent to a product flow F_{P} passing through a heat-absorbing product chamber 22.1, with the product flow F_{P} being heated from a product input temperature T_{PE} to a product output temperature T_{PA} and at least the product output temperature T_{PA} and the heating medium inlet temperature T_{ME} being monitored and regulated.

The first method is characterized by the following method steps (A1), (B1), (C), (D1), (E), and (F), which are shown graphically in their conditional relationship and meaning in FIG. 3.

The method step (A1) includes setting an unknown product-specific temperature curve [T_{P}(Iₓ)]_{PE-PA} between the product input temperature T_{PE} and the product output temperature T_{PA} with the aid of a supply of the required heating medium flow F_{M} with the required heating medium inlet temperature T_{ME} at a heating medium inlet E_{M} into the heating medium chamber 22.2 and measuring discrete product temperatures T_{P} or T_{P1} to T_{Pa} at specified measurement points 22.3 in the product flow F_{P}.

The method step (B1) includes specifying the product input temperature T_{PE} at a product input E_{P} into the product chamber 22.1 and the product output temperature T_{PA} at a product output A_{P} from it and providing the heating medium inlet temperature T_{ME} and the heating medium flow F_{M}.

The method step (C) includes measuring a product-specific temperature curve T_{P}(Iₓ) between the product output A_{P} and the product input E_{P} at the specified measurement points 22.3;

The method step (D1) includes comparing the temperature curves for method steps (A1) and (C) and calculating temperature deviations ΔT_{P} at the specified measurement points 22.3.

The method step (E) includes specifying a permitted temperature deviation [ΔT_{P}]₀.

The method step (F) includes changing of the heating medium inlet temperature T_{ME} to a target heating medium inlet temperature T_{ME}* when the permitted temperature deviation [ΔT_{P}]₀ is exceeded by the calculated temperature deviation ΔT_{P}.

### Second Method

The second method also starts from the previously described known method and is characterized by the following method steps (A2), (B2), (C), (D2), (E), and (F), with the method steps (C), (E), and (F) being identical to the method steps having the same labels in the first method. The method steps of the second method are also illustrated graphically in FIG. 3 in their conditional relationship and their meaning.

The method step (A2) includes setting a known product-specific target temperature curve [T_{P}(Iₓ)]₀ with the aid of measuring discrete product temperatures T_{P} and T_{P1} to T_{P}, respectively at specified measurement points 22.3 in the product flow F_{P} and with the aid of a supply of the required heating medium flow F_{M} with the required heating medium inlet temperature T_{ME} at a heating medium inlet E_{M} into the heating medium chamber 22.2.

The method step (B2) includes specifying the product-specific target temperature curve [T_{P}(Iₓ)]₀, which includes the product input temperature T_{PE} at a product input E_{P} into the product chamber 22.1 and the product output temperature T_{PA} at a product output A_{P} out of it, and providing a stored supply of the heating medium flow F_{M} with a heating medium inlet temperature T_{ME}.

The method step (C) includes measuring a product-specific temperature curve T_{P}(Iₓ) between the product output A_{P} and the product input E_{P} at the specified measurement points 22.3.

The method step (D2) includes comparing the temperature curves for method steps (A2) and (C) and calculating temperature deviations ΔT_{P} at the specified measurement points 22.3.

The method step (E) includes specifying a permitted temperature deviation [ΔT_{P}]₀.

The method step (F) includes changing of the heating medium inlet temperature T_{ME} to a target heating medium inlet temperature T_{ME}* when the permitted temperature deviation [ΔT_{P}]₀ is exceeded by the calculated temperature deviation ΔT_{P}.

Both the first and the second method can be advantageously embodied in each case with additional method steps (G), (H), (I), and (J), which are also illustrated graphically in FIG. 3 in their conditional relationship and their meaning.

The method step (G) includes determining a temperature/time gradient ΔT_{ME}/Δt from a change of the heating medium inlet temperature T_{ME} in a specified time span Δt.

The method step (H) includes specifying a reference gradient [ΔT_{ME}/Δt]₀ for a permitted temperature increase of the heating medium inlet temperature T_{ME} in the time span Δt.

The method step (I) includes comparing the results of the method step (G) with the specification according to the method step (H).

The method step (J) includes changing the heating medium flow F_{M} to a target heating medium flow F_{M}* when the reference gradient [ΔT_{ME}/Δt]₀ is exceeded by the temperature/time gradient ΔT_{ME}/Δt determined.

Analogous to the representation in FIG. 2, the temperature curves T_{P}(Iₓ) and T_{M}(Iₓ) shown in FIG. 5 are observed during the operation time of the heat exchanger unit 22, entered over the variable heat exchanger path Iₓ. The product-specific temperature curve in the specified, heat-absorbing product flow F_{P} to be treated between the product input temperature T_{PE} (for example, 125° C.) provided by the upstream process unit 21 and the product output temperature T_{PA} (for example, 140° C.) necessary to ensure sufficient aseptic heating is designated in turn by T_{P}(Iₓ). T_{M}(Iₓ) is the designation for two heating medium-specific temperature curves in the heat-releasing heating medium flow F_{M}. The lower temperature curve, with reference to the position in the drawing, between a third heating medium inlet temperature T_{ME}(3) (for example, 141.7° C.) and a third heating medium outlet temperature T_{MA}(3) (for example, 128.8° C.) is at the beginning of the operation time if the heat exchanger unit 22 is still free of any deposits (product fouling) on the product side.

At the end of the operation time, after 12 hours for example, the control and feedback unit 24 has increased the heating medium inlet temperature T_{ME} so much that a fourth heating medium inlet temperature T_{ME}(4) (for example, 144° C.) is now necessary at the heating medium inlet E_{M}. The third heating medium outlet temperature T_{MA}(3) necessarily establishing itself at the heating medium outlet A_{M} at the beginning of the operation time is essentially dependent on a third mass flow ratio f(3), comprised as a ratio of a third heating medium flow F_{M}(3) and the product flow F_{P} on one hand (f(3)=F_{M}(3)/F_{P}=1.14) and the other influencing parameters cited above in conjunction with FIG. 2.

A fourth heating medium outlet temperature T_{MA}(4) (for example, 134.6° C.) necessarily establishing itself at the heating medium outlet A_{M} at the end of the operation time is essentially dependent on a fourth mass flow ratio f(4), comprised as a quotient of a fourth heating medium flow F_{M}(4) and the product flow F_{P} on one hand (f(4)=F_{M}(4)/F_{P}=1.57) and the other influencing parameters cited above in conjunction with FIG. 2.

At the beginning of the operation time, the heat exchanger unit 22 is operated with a minimum value for the third heating medium flow F_{M}(3), with which, in conjunction with a minimum value for the third heating medium inlet temperature T_{ME}(3), it is ensured to achieve and maintain the product output temperature T_{PA} and the product input temperature T_{PE}.

In contrast to the known method, as part of the increase of the heating medium inlet temperature from T_{ME}(3) to T_{ME}(4), the heating medium flow F_{M} is increased from the minimum value F_{M}(3) to the maximum value F_{M}(4) in a stepwise or continuous manner. This results in a significantly smaller temperature difference between the product temperature T_{P} and the heating medium temperature T_{M} at the product input E_{P} and heating medium outlet A_{M} respectively compared to the known method. Advantages in this regard with respect to a lesser buildup for the product input E_{P} were already described above in conjunction with FIG. 2.

The specialist recognizes the accumulated product fouling deposit during the operation time from the average logarithmic temperature difference ΔT_{M} as already described. In the present case, according to this disclosure, at the beginning of the operation time, a third average logarithmic temperature difference ΔT_{M}(3) is 2.6° C. and at the end of the operation time a fourth average logarithmic temperature difference ΔT_{M}(4) is 6.4° C. In this respect, these values correspond approximately to those in the method of prior art.

In contrast to the known method, equations (2.1) and (2.2) with correspondingly modified parameters yield altogether a lower quantity of accumulation compared to the known method as a result of the significant reduction of the temperature difference throughout the entire heat exchanger path L from ΔTₛₘₐₗₗ(3)=1.7° C. to ΔT_{large}(3)=3.8° C. (a factor of 2.2) from the beginning of the operation time up to the end of the operation time, then still from ΔTₛₘₐₗₗ(4)=4° C. to ΔT_{large}(4)=9.6° C. (a factor of 2.4) at the end of the operation time from the product fouling, considered over the entire heat exchange surface A. This circumstance is particularly due at the beginning and in the first half of the operation time where the temperature difference, i.e., the ratio of ΔT_{large}(3)=3.8° C. to ΔTₛₘₐₗₗ(3)=1.7° C., is only a factor of 2.2, whereas in the known method with ΔT_{large}(1)=5.6° C. to ΔTₛₘₐₗₗ(1)=0.9° C. it acts on the product fouling with a factor of 6.2.

A comparison of the relevant data for heat exchange in the known method according to FIG. 2 and the method according to FIG. 5 is shown in the following table.

| Designation | FIG. 2 | | FIG. 5 | |
|---|---|---|---|---|
| Unit of measure | | [° C.] | | [° C.] |
| Product input temperature | T_{PE} | 125.0 | T_{PE} | 125.0 |
| Product output temperature | T_{PA} | 140.0 | T_{PA} | 140.0 |
| Heating medium inlet temperature | T_{ME}(1) | 140.9 | T_{ME}(3) | 141.7 |
| Heating medium inlet temperature | T_{ME}(2) | 144.5 | T_{ME}(4) | 144.0 |
| Heating medium outlet temperature | T_{MA}(1) | 130.6 | T_{MA}(3) | 128.8 |
| Heating medium outlet temperature | T_{MA}(2) | 134.2 | T_{MA}(4) | 134.6 |
| Small temperature difference | ΔTₛₘₐₗₗ(1) | 0.9 | ΔTₛₘₐₗₗ(3) | 1.7 |
| Small temperature difference | ΔTₛₘₐₗₗ(2) | 4.5 | ΔTₛₘₐₗₗ(4) | 4.0 |
| Large temperature difference | ΔT_{large}(1) | 5.6 | ΔT_{large}(3) | 3.8 |
| Large temperature difference | ΔT_{large}(2) | 9.2 | ΔT_{large}(4) | 9.6 |
| Average logarithmic temperature difference | ΔT_{M}(1) | 2.6 | ΔT_{M}(3) | 2.6 |
| Average logarithmic temperature difference | ΔT_{M}(2) | 6.6 | ΔT_{M}(4) | 6.4 |
| Unit of measure | | [1] | | [1] |
| Mass flow ratio | f(1) | 1.43 | f(3) | 1.14 |
| Mass flow ratio | f(2) | 1.43 | f(4) | 1.57 |

A product-specific temperature limit curve of the product flow F_{P} designated in turn in FIG. 5 as T_{P}(Iₓ)′—is theoretical in nature with respect to its linear plot between the product input temperature T_{PE} and the product output temperature T_{PA}, just like a linear temperature curve in the heating medium flow F_{M}, which is not shown, as already indicated above in conjunction with the known method. As FIG. 5 shows, in the method described herein, success was achieved in the context of the available influencing parameters in bringing the actual temperature curve in the product P and in the heating medium M closer together than in the known method.

FIG. 5 also graphically shows the method steps D1 and D2 respectively and E and F. A permitted downward temperature deviation is designated as −[ΔT_{P}]₀ and an upward one with +[ΔT_{P}]₀. This results in a lower temperature limit curve [T_{P}(Iₓ)]* and an upper temperature limit curve [T_{P}(Iₓ)]**. The product-specific temperature curve T_{P}(Iₓ) is measured via the discrete temperatures T_{P} in the region close to the product output A_{P} by the arrangement of the temperature measurement points 22.3. Here the first product temperature T_{P1} is located at the discrete heat exchanger path Iₓ₁ (T_{P}(Iₓ₁)) and the second product temperature T_{P2} and third product temperature T_{P3} are measured in each case at measurement point intervals ΔI one after the other in the direction of flow of the liquid product P. If the product-specific temperature curve T_{P}(Iₓ) diverges particularly from this region, then, in accordance with the invention as described above and illustrated in FIG. 3, this is counteracted by the influencing parameters for the target heating medium inlet temperature T_{M}* and target heating medium flow F_{M}*.

As shown in FIG. 6A, the heat exchanger unit 22 is subdivided into multiple sections 22a connected in series to one another. Here, adjacent sections 22a are connected to one another in each case via a first connecting element 32 through which liquid product P flows on the product side and via a second connecting element 33 on the heating medium side, whereby, if required, the respective temperature measurement points 22.3 are provided in a necessary number of first connecting elements 32.

The instrumental embodiment of the heat exchanger unit 22 is accomplished in a particularly easy manner if it is implemented as a tubular heat exchanger as shown in FIG. 6A, in which the heat-absorbing product chamber 22.1 and the heat-releasing heating medium chamber 22.2 which surrounds the product chamber 22.2 externally preferably have in each case the form of a straight section of tubing. The subdivision of the length of tubing in sections of equal length or also of different lengths results in the sections 22a. Here there are two fundamentally differing embodiments, specifically a first in which the individual section 22a of the tubular heat exchanger 22 is formed on the product side in each case as a monotube 22.1* through which liquid product P flows, said monotube being concentrically enclosed by the heating medium chamber 22.2 in the form of a tube-shaped external jacket as shown in FIG. 6B.

In the second embodiment, a so-called shell-and-tube heat exchanger 22, the individual section 22a is formed as a tube bundle 22.1** with a number of parallel interior tubes 22.1*** through which liquid product P flows as shown in FIG. 6C. Here these interior tubes 22.1*** are not only arranged in the Meridian level of the heating medium chamber 22.2, which surrounds the interior tubes 22.1*** altogether as a tube-shaped external jacket as shown in a simplifying manner in FIG. 6C, but are also distributed as evenly as possible over the entire cross-section of this external jacket.

As shown in FIG. 6A, the first connecting element 32 is preferably formed in each case as a connecting bend, for example as a 180° pipe bend, or as a connection fitting with another geometric form which necessarily ensures an interior passage. The second connecting element 33 is designed, for example, in the form of a short pipe connection which connects adjacent external jackets of the heating medium chamber 22.2 to one another in their end region in each case.

The arrangement of the necessary temperature measurement points 22.3 is very easily possible by the embodiment of the heat exchanger unit 22 shown above in the form of a tubular heat exchanger or shell-and-tube heat exchanger 22 subdivided in sections 22a, because access to the product flow F_{P} is given directly at defined measurement point intervals ΔI in each case via the first connecting element 32 without needing to reach into the section 22a itself and through the heating medium chamber 22.2 in a complicated manner. The first, second and third product temperature—T_{P1}, T_{P2} and T_{P3} respectively are obtained at the temperature measurement points 22.3 in the embodiment example by the respective measuring apparatus for discrete product temperature 25. The arrangement of the associated temperature measurement points 22.3 in the embodiment example is done based on FIG. 4 in such a way that, viewed in the direction of flow of the liquid product P, upstream of the product output A_{P} and at a defined spacing from it, they are arranged necessarily in series with respect to one another and with defined spacing from one another, specifically with the spacing of the preferably equal length of the section 22a in each case.

The list of reference numbers used in the drawing figures is as follows.
10 arrangement according to prior art
21 upstream process unit
22 heat exchanger unit
22.1 heat-absorbing product chamber
22.2 heat-releasing heating medium chamber
23 downstream process unit
24 control and feedback unit
26 measuring apparatus for product flow (F_{P})
28.1 measuring apparatus for product input temperature (T_{PE})
28.2 measuring apparatus for product output temperature (T_{PA})
29 measuring apparatus for heating medium flow (F_{M})
30.1 measuring apparatus for heating medium inlet temperature (T_{ME})
31.1 outlet for target medium inlet temperature (T_{ME}*)
31.2 outlet for target heating medium flow (F_{M}*)
A heat exchange surface (of the heat exchanger unit 22)
A_{M} heating medium outlet
A_{P} product output
E_{M} heating medium inlet
E_{P} product input
F_{M} heating medium flow in kg/s, for example
F_{M}* target heating medium flow
F_{M}(1) first heating medium flow
F_{M}(2) second heating medium flow
F_{P} product flow in kg/s, for example
L total heat exchanger path
M heating medium
P liquid product
Q heat flow, for example in W=J/s
T_{M} heating medium temperature
T_{M}(Iₓ) heating medium-specific temperature curve, general
T_{MA} heating medium outlet temperature, general
T_{MA}(1) first heating medium outlet temperature
T_{MA}(2) second heating medium outlet temperature
T_{ME} heating medium inlet temperature, general
T_{ME}* target heating medium inlet temperature, general
T_{ME}(1) first heating medium inlet temperature
T_{ME}(2) second heating medium inlet temperature
T_{P} product temperature
T(Iₓ) product-specific temperature curve, general
T_{P}(Iₓ)′ product-specific temperature limit curve
T_{P}(Iₓ₁) discrete temperature of the liquid product
T_{PA} product output temperature
T_{PE} product input temperature
ΔT_{large}(1) first large temperature difference
ΔT_{large}(2) second large temperature difference
ΔTₛₘₐₗₗ(1) first small temperature difference
ΔTₛₘₐₗₗ(2) second small temperature difference
ΔTₘ average logarithmic temperature difference, general
ΔT_{M}(1) first average logarithmic temperature difference
ΔT_{M}(2) second average logarithmic temperature difference
c_{M} specific heat capacity of the heating medium (M)—in J/(kgK) for example
c_{P} specific heat capacity of the liquid product (P)—in J/(kgK) for example
F mass flow ratio, general
f(1) first mass flow ratio
f(2) second mass flow ratio
K heat transfer coefficient, for example in W/(m²K)=J/(m² sK); K=Kelvin
Iₓ variable heat exchanger path
Iₓ₁ discrete heat exchanger path (at the point Iₓ₁)
A1 setting of an unknown product-specific temperature curve [T_{P}(Iₓ)]_{PE-PA}
A2 setting of a known product-specific target temperature curve [T_{P}(Iₓ)]₀
B1 specifying the product input temperature T_{PE} and the product output temperature T_{PA} and providing the heating medium inlet temperature T_{ME} and heating medium flow F_{M}
B2 specifying the known product-specific target temperature curve [T_{P}(Iₓ)]₀ and providing the heating medium flow F_{M} with a heating medium inlet temperature T_{ME}
C measurement of a product-specific temperature curve T_{P}(Iₓ)
D1 comparing the temperature curves for the method steps (A1) and (C) and calculating temperature deviations ΔT_{P}
D2 comparing the temperature curves for method steps (A2) and (C) and calculating temperature deviations ΔT_{P}
E specifying a permitted temperature deviation [ΔT_{P}]₀
F changing the heating medium inlet temperature T_{ME}
G determining a temperature/time gradient ΔT_{ME}/Δt
H specifying a reference gradient [ΔT_{ME}/Δt]₀
I comparing the results of method step (G) with the specification according to method step (H);
J changing the heating medium flow F_{M}
20 arrangement
22a Section
22.1* Monotube
22.1** tube bundle
22.1*** interior tube
22.3 temperature measurement point
25 measuring apparatus for discrete product temperature T_{P}; T_{P1} to T_{Pn}
27.1 measuring apparatus for product inlet pressure (p_{E})
27.2 measuring apparatus for product outlet pressure (p_{A})
30.2 measuring device for heating medium outlet temperature (TMA)
32 first connecting element
33 second connecting element
F_{M}(3) third heating medium flow
F_{M}(4) fourth heating medium flow
T_{MA}(3) third heating medium outlet temperature
T_{MA}(4) fourth heating medium outlet temperature
T_{ME}(3) third heating medium inlet temperature
T_{ME}(4) fourth heating medium inlet temperature
T_{P} discrete product temperature, general
T_{P1} first product temperature
T_{P2} second product temperature
T_{P3} third product temperature
T_{Pi} i^{th} product temperature
T_{Pn} n^{th} product temperature
[T_{P}(Iₓ)]_{PE-PA} unknown, product-specific temperature curve between the product input temperature T_{PE} and the product output temperature T_{PA}
[T_{P}(Iₓ)]₀ known product-specific target temperature curve
[T_{P}(Iₓ)]* lower temperature limit curve
[T_{P}(Iₓ)]** upper temperature limit curve
ΔT_{ME}/Δt temperature/time gradient
[ΔT_{ME}/Δt]₀ reference gradient
ΔT_{M}(3) third average logarithmic temperature difference
ΔT_{M}(4) fourth average logarithmic temperature difference
ΔT_{large}(3) third large temperature difference
ΔT_{large}(4) fourth large temperature difference
ΔTₛₘₐₗₗ(3) third small temperature difference
ΔTₛₘₐₗₗ(4) fourth small temperature difference
±ΔT_{P} temperature deviation (+: upward; −: downward)
±[ΔT_{P}]₀ permitted temperature deviation (+: upward; −: downward)
f(3) third mass flow ratio
f(4) fourth mass flow ratio
ΔI measurement point interval
p_{A} product outlet pressure
p_{E} product inlet pressure
t Time
Δt time span

1. A method for aseptic heating of a liquid product (P) in a heat exchanger unit of a heater zone of an arrangement in a ultra-high temperature (UHT) system in which an indirect heat exchange on a wall takes place in the heat exchanger unit between the liquid product and a heating medium by a flowing heating medium flow with a heating medium inlet temperature in a heat-releasing heating medium chamber being guided countercurrent to a product flow ) in a heat-absorbing product chamber, in which the product flow is heated from a product input temperature to a product output temperature and in which at least the product output temperature and the heating medium inlet temperature are monitored and regulated, the method comprising:
(A1) setting an unknown product-specific temperature curve between the product input temperature and the product output temperature with the aid of a supply of a required heating medium flow with a required heating medium inlet temperature at a heating medium inlet into the heating medium chamber and measuring discrete product temperatures at specified measurement points in the product flow;
(B1) specifying the product input temperature at a product input into the product chamber and the product output temperature at a product output from it and providing the heating medium inlet temperature and heating medium flow;
(C) measuring a product-specific temperature curve between the product output and the product input at the specified measurement points;
(D1) comparing the temperature curves for method steps (A1) and (C) and calculating the respective temperature deviations at the specified measurement points;
(E) specifying a permitted temperature deviation; and
(F) changing of the heating medium inlet temperature to a target heating medium inlet temperature when the permitted temperature deviation is exceeded by the calculated temperature deviation.

2. A method for aseptic heating of a liquid product in a heat exchanger unit of a heater zone of an arrangement in a ultra-high temperature (UHT) system in which an indirect heat exchange on a wall takes place in the heat exchanger unit between the liquid product and a heating medium by a flowing heating medium flow with a heating medium inlet temperature in a heat-releasing heating medium chamber being guided countercurrent to a product flow in a heat-absorbing product chamber, in which the product flow is heated from a product input temperature to a product output temperature and in which at least the product output temperature and the heating medium inlet temperature are monitored and regulated, the method comprising:
(A2) setting a known product-specific target temperature curve with the aid of measuring discrete product temperatures at specified measurement points in the product flow and with the aid of a supply of a required heating medium flow with a required heating medium inlet temperature at a heating medium inlet into the heating medium chamber;
(B2) specifying the product-specific target temperature curve, which includes the product input temperature at a product input into the product chamber and the product output temperature at a product output out of it, and providing a stored supply of the heating medium flow with a heating medium inlet temperature;
(C) measuring a product-specific temperature curve between the product output and the product input at the specified measurement points;
(D2) comparing the temperature curves for method steps (A2) and (C) and calculating temperature deviations at the specified measurement points;
(E) specifying a permitted temperature deviation; and
(F) changing the heating medium inlet temperature to a target heating medium inlet temperature when the permitted temperature deviation is exceeded by the calculated temperature deviation.

3. The method according to claim 1, further comprising:
(G) determining a temperature/time gradient from a change of the heating medium inlet temperature in a specified time span;
(H) specifying a reference gradient for a permitted temperature increase of the heating medium inlet temperature in the time span;
(I) comparing the results of method step (G) with the specification according to method step (H); and
(J) changing the heating medium flow to a target heating medium flow when the reference gradient is exceeded by the temperature/time gradient determined.

4. The method according to claim 1, wherein the change of the heating medium inlet temperature to the target heating medium inlet temperature occurs in each case either in temperature steps or by a continuous temperature change.

5. The method according to claim 1, wherein the change of the heating medium flow to the target heating medium flow occurs in each case either by a stepwise or by a continuous increase.

6. The method according to claim 1, further comprising:
measuring a product inlet pressure at a product input and a product outlet pressure at a product output.

7. An arrangement for carrying out the method according to claim 1, with the heat exchanger unit which, seen in the direction of flow of a liquid product to be heated indirectly, is situated between an upstream process unit and a downstream process unit, with the heat exchanger unit, which has a flow-through heat-absorbing product chamber and a flow-through heat-releasing heating medium chamber, with at least one measuring apparatus for product flow, one measuring apparatus for product input temperature, one measuring apparatus for product output temperature, one measuring apparatus for heating medium flow and one measuring apparatus for heating medium inlet temperature, and with a control and feedback unit that controls an output for target heating medium inlet temperature and an output for target heating medium flow, provided on the control and feedback unit, dependent on at least the measuring apparatuses, wherein, in the product chamber of the heat exchanger unit, upstream of the product output and adjacent thereto with defined spacing, at least one temperature measurement point is provided, which is connected to the control and feedback unit via a measuring apparatus for discrete product temperature assigned in each case for measuring discrete product temperatures.

8. The arrangement according to claim 7, wherein, with more than one temperature measurement point, these points are arranged contrary to the direction of flow of the liquid product in series with respect to one another and with defined spacing from one another.

9. The arrangement according to claim 7, wherein the at least one temperature measurement point is arranged in the last third of the flow-through product chamber.

10. A heat exchanger unit for the arrangement according to claim 7, wherein the heat exchanger unit is subdivided into multiple sections connected to one another in series, in that adjacent sections are connected to one another in each case via a first connecting element through which liquid product flows on a product side and via a second connecting element on a heating medium side and in that the respective temperature measurement point is provided in the first connecting element.

11. A heat exchanger unit according to claim 10, wherein the heat exchanger unit is formed as a tubular heat exchanger, that an individual section of the multiple sections of the tubular heat exchanger is formed on the product side in each case as a monotube through which liquid product flows or as a tube bundle with a number of parallel interior tubes through which liquid product flows and in that the first connecting element is formed in each case as a connecting bend or as a connection fitting.

12. The arrangement according to claim 8, wherein the at least one temperature measurement point is arranged in the last third of the flow-through product chamber.

13. A method according to claim 2, further comprising:
(G) determining a temperature/time gradient from a change of the heating medium inlet temperature in a specified time span;
(H) specifying a reference gradient for a permitted temperature increase of the heating medium inlet temperature in the time span;
(I) comparing the results of method step (G) with the specification according to method step (H); and
(J) changing the heating medium flow to a target heating medium flow when the reference gradient is exceeded by the temperature/time gradient determined.

14. The method according to claim 2, wherein the change of the heating medium inlet temperature to the target heating medium inlet temperature occurs in each case either in temperature steps or by a continuous temperature change.

15. The method according to claim 2, wherein the change of the heating medium flow to the target heating medium flow occurs in each case either by a stepwise or by a continuous increase.

16. The method according to claim 2, further comprising:
measuring a product inlet pressure at a product input and a product outlet pressure at a product output.

17. The method according to claim 1, wherein the heat exchanger unit is formed as a tubular heat exchanger, and is formed on the product side as a monotube through which liquid product flows or as a tube bundle with a number of parallel interior tubes through which liquid product flows.
